(19) United States
(12) Patent Application Publication
(10) Pub. No.: US 2012/0126100 A1
(43) Pub. Date: May 24, 2012

(54) Photoelectric Switch

(75) Inventors: Koji Fukumura, Osaka (JP); Yutaka Miyamoto, Osaka (JP)

(73) Assignee: KEYENCE CORPORATION, Osaka (JP)

(21) Appl. No.: 13/278,231

(22) Filed: Oct. 21, 2011

(30) Foreign Application Priority Data
Nov. 19, 2010 (JP) 2010-259591

(51) Int. Cl. G01J 1/44

(52) U.S. Cl. 250/214 SW

(57) ABSTRACT

A photoelectric switch can be widely applied with a function to sensuously and intuitively display a light-receiving amount as an artificial numeric value in a given range. A preset display value “100” is set to an average value of sampled light-receiving amounts (S2). A preset display value “0” is allocated to a light-receiving amount of “0” already held by the photoelectric switch (S3), to obtain a preset display conversion factor (S4). When an operation based on this preset display conversion formula is disadvantageous, an average value of the sampled actual light-receiving amounts is set to a preset display value “0 (zero)” (S23), and a preset display conversion formula, obtained by substituting the above actual light-receiving amount for the light-receiving amount with respect to the preset display value “0” in the already created preset display conversion formula, is created (S22).

### CROSS-REFERENCE TO RELATED APPLICATIONS

The present application claims foreign priority based on Japanese Patent Application No. 2010-259591, filed Nov. 19, 2010, the contents of which is incorporated herein by reference.

### BACKGROUND OF THE INVENTION

1. Field of the Invention

The present invention relates to a photoelectric switch for detecting the presence or absence of an object to be detected in a noncontact manner.

2. Description of Related Art

The photoelectric switch is typically installed on a production line of a factory and used for detecting the presence or absence of a moving object. This kind of photoelectric switch is roughly classified into a reflective type and a transmissive type. A reflective photoelectric switch projects light from a light-projecting part toward an object and sensing reflected light from the object in a light-receiving part, to detect the existence of the object (Unexamined Japanese Patent Publication No. 2006-236848). A transmissive photoelectric switch senses, by the light-receiving part, that light projected from the light-projecting part has been blocked by an object, to detect the existence of the object (Unexamined Japanese Patent Publication No. 2006-236849).

The photoelectric switch is typically provided with a display part made up of 7-segment display, and a variety of information are displayed using this display part. Principal display items during an operation include a light-receiving amount, a threshold and a scaling value, and the display item can be switched by operating an operation button provided in the photoelectric switch (Unexamined Japanese Patent Publication No. 2006-351380).

Unexamined Japanese Patent Publication No. 2006-236845 discloses a scaling function. The scaling function is a function to match displays of a plurality of photoelectric switches, and specifically a function to unify target light-receiving amounts into an artificial arbitrary value, such as “5000”. According to this, it is possible to match display values of a plurality of photoelectric switches having individual differences without an operation to adjust optical characteristics of the photoelectric switches, so as to provide operational and administrative convenience.

“KEYENCE General Catalog 2011” (published in April, 2010) discloses a preset function. This preset function is a function developed from the above scaling function, in which a target light-receiving amount is set to “100” and a display defined by 0 (zero) and 100 is performed. The numeric range from 0 to 100 is widely and generally familiar as a percent (%). Therefore, when the photoelectric switch displays a numeric value of “90” which is less than “100”, the administrator can sensuously and intuitively become aware that a status change has occurred in operating state or environment of the photoelectric switch just by looking at this numeric value less than “100”.

A conventional setting procedure for the preset function will be described as follows. First, light-receiving amounts are sampled. Next, a target preset value of “100” is set to an average value of the sampled actual light-receiving amounts. Subsequently, a target preset value “0 (zero)” is allocated to a light-receiving amount “0 (zero)”. Then, a scaling conversion factor and a scaling conversion formula are created based on these values, to implement an operation of a scaling display mode based on this scaling conversion formula. In addition, as for setting of a threshold, the photoelectric sensor generally has a function to automatically set a half value of a light-receiving amount, and a preset display value for a threshold of “50” is allocated to this threshold.

### SUMMARY OF THE INVENTION

Typically, the conventional preset function is effectively applicable to a transmissive photoelectric switch. However, it has been revealed that this function may not always be suitable for the reflective photoelectric switch.

For example, as for a shiny object and a mirror-finished object, a light-receiving amount in a state with the object is larger than a light-receiving amount on a background (in a state without the object). As opposed to this, as for a darkly-colored object, a light-receiving amount in the state with the object is smaller than a light-receiving amount on the background (in the state without the object). For this reason, when the state without the object is set to a preset display value “100” and the state with the object is set to a preset display value “0 (zero)”, in the case of the mirror-finished object, the preset display value remains unchanged from “100”. On the contrary, when the state without the object is set to the preset display value “0 (zero)” and the state with the object is set to the preset display value “100”, in the case of the darkly-colored object, the preset display value remains unchanged from “100”. This problem is not restricted to the preset display function, but is a common problem among photoelectric switches each provided with the foregoing scaling function, namely a display function to display a light-receiving amount as an artificial numeric value in a given range.

Thereat, an object of the present invention is to provide a photoelectric switch of either a transmissive type or a reflective type, which can be widely applied with a function to sensuously and intuitively display a light-receiving amount as an artificial numeric value in a given range.

A further object of the present invention is to provide a photoelectric switch which can perform stable detection by a simple operation and can be widely applied with a sensuous and intuitive display aspect.

According to the present invention, the above technical objects can be achieved by providing:

a photoelectric switch, which includes a display part, and converts each of a light-receiving amount in a state “present object” and a light-receiving amount in a state “absent object” to an artificial numeric display value defined by a range of an upper limit and a lower limit, to display the display value of the light-receiving amount in the display part,

the switch including a light-receiving amount setting device for setting a light-receiving amount measured by the photoelectric switch as a light-receiving amount corresponding to one value of the upper limit or the lower limit among parameters required for creating a light-receiving amount display conversion relation for converting a light-receiving amount of the photoelectric switch to the display value,

a light-receiving amount allocating device for allocating a light-receiving amount that is already held by the photoelectric switch as a light-receiving amount corresponding to the other value of the upper limit and the lower limit,

a light-receiving amount display conversion factor setting device for creating the light-receiving amount display conversion relation based on the light-receiving amount measured by the photoelectric switch and the allocated light-receiving amount, to set this created light-receiving amount display conversion relation, and

a first conversion relation updating device for substituting the allocated light-receiving amount for the light-receiving amount measured by the photoelectric switch as the light-receiving amount corresponding to the other value of the upper limit and the lower limit, to update the light-receiving amount display conversion relation.

When the foregoing problem occurs, a light-receiving amount corresponding to the other value of the upper limit and the lower limit is converted to a display value by use of the first conversion relation updating device, to display a light-receiving amount based on the light-receiving amounts obtained by measuring both the upper limit and the lower limit so that the foregoing problem can be solved.

When a description is given using the example of a preset display with an upper limit of “100” and a lower limit of “0”, for example, “100” is set to a light-receiving amount of a measured value, and the lower limit of “0” is allocated to a light-receiving amount of “0” which has already been held by the photoelectric switch, to set a light-receiving amount display conversion factor. Then, when an operation cannot be performed in an advantageous manner with this light-receiving amount display conversion factor, a measured light-receiving amount is set to the lower limit of “0”, the light-receiving amount of “0” held by the photoelectric switch is substituted by the measured light-receiving amount having been set to the lower limit of “0”, to update the light-receiving amount display conversion factor by the first conversion relation updating device so that the foregoing problem can be solved.

In a preferred embodiment of the present invention,

the display part is configured by a first display and a second display adjacent thereto,

the switch further has a threshold converting device for converting a threshold of the photoelectric switch to the display value in a range between an upper limit and a lower limit, and

during an operation mode on which the presence or absence of an object to be detected is detected while the display value of the light-receiving amount is displayed in the display part, the display value of the threshold is displayed on the first display and the display value of the light-receiving amount of the photoelectric switch is displayed on the second display. The threshold is also displayed as the display value in a range between an upper limit and a lower limit so that thresholds can be uniformly managed.

When the light-receiving amount display conversion relation needs to be updated in the operating process, the light-receiving amount measured by the photoelectric switch and set as the light-receiving amount corresponding to the one value (e.g., “100”) of the upper limit and the lower limit may be substituted by a newly current measured light-receiving amount, to update the light-receiving amount display conversion relation.

Herein, the light-receiving amount display conversion relation includes later-mentioned preset display conversion formula, preset conversion factor, scaling display conversion formula and scaling conversion factor, and means a so-called conversion table which, in addition to the above, previously stores a conversion relation between a light-receiving amount and an artificially numeric value thereof.

The present invention is most typically applied to a separate photoelectric switch. Since the separate type includes a controller and a display part is provided in this controller, when a plurality of controllers are adjacently arrayed, it is possible to perform an operation with displays of all the controllers matched in an extremely simple manner.

### BRIEF DESCRIPTION OF THE DRAWINGS

FIG. 1 is a block diagram of a general configuration of a photoelectric switch;

FIG. 2 is a block diagram of a configuration that realizes an adjustment function of the photoelectric switch;

FIG. 3 is a perspective view showing a state where a plurality of controllers of a separate photoelectric switch are horizontally arranged;

FIG. 4 is a plan view of the plurality of controllers, arranged in a mutually aligned manner, of the separate photoelectric switch shown in FIG. 3;

FIG. 5 is a flowchart for explaining a preset display setting procedure, in which three modes can be properly used just by changing an operation of a preset button;

FIG. 6 is a flowchart for explaining an operation and a procedure for updating or resetting the setting of the preset display;

FIGS. 7A to 7C are diagrams for each explaining a button operation, performed at the time of changing a set value after completion of preset setting, and a set item changed thereby, where FIG. 7A relates to setting of a first operation mode, FIG. 7B relates to setting of a second operation mode, and FIG. 7C relates to setting of a third operation mode;

FIGS. 8A to 8C are diagrams for each explaining a button operation, performed at the time of making a change including a setting method after completion of preset setting, and a set item changed thereby, where FIG. 8A relates to setting of the first operation mode, FIG. 8B relates to setting of the second operation mode, and FIG. 8C relates to setting of the third operation mode;

FIGS. 9A to 9C are diagrams for each explaining a button operation, performed at the time of changing a threshold after completion of preset setting, and a set item changed thereby, where FIG. 9A relates to setting of the first operation mode, FIG. 9B relates to setting of the second operation mode, and FIG. 9C relates to setting of the third operation mode; and

FIGS. 10A to 10C are diagrams for each explaining a button operation, performed at the time of changing a threshold and also changing a setting method after completion of preset setting, and a set item changed thereby, where FIG. 10A relates to setting of the first operation mode, FIG. 10B relates to setting of the second operation mode, and FIG. 10C relates to setting of the third operation mode.

### DETAILED DESCRIPTION OF PREFERRED EMBODIMENTS

### Examples

Hereinafter, preferred examples of the present invention will be described based on the attached drawings.

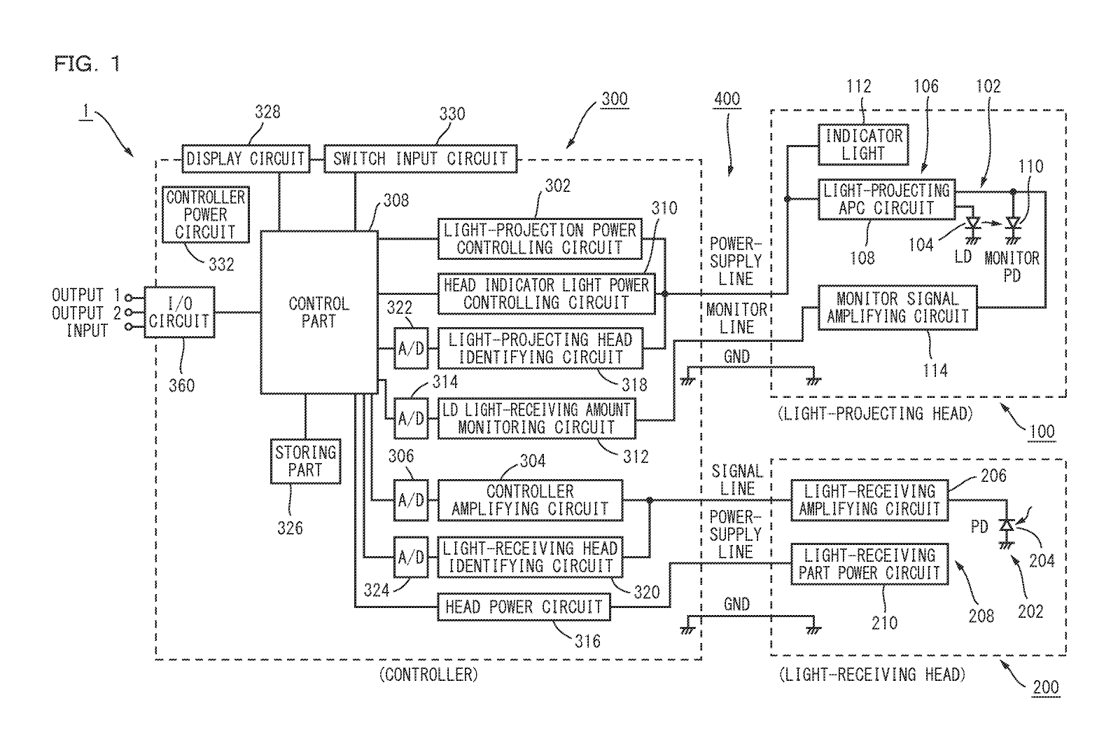

FIGS. 1 to 4 are diagrams and views related to a transmissive photoelectric switch of an example. A transmissive photoelectric switch 1 shown in the figures has a light-projecting head 100, a light-receiving head 200 and a controller 300, and the light-projecting head 100 and the light-receiving head 200 are connected to the controller 300 via a head cable 400. That is, the transmissive photoelectric switch 1 is a separate photoelectric switch in which the light-projecting head 100, the light-receiving head 200 and the controller 300 are physically separated and these are connected by the cable 400.

FIG. 1 is a block diagram of the photoelectric switch 1. The light-projecting head 100 is provided with a light-projecting part 102. Meanwhile, the light-receiving head 200 is provided with a light-receiving part 202. The controller 300 outputs a predetermined pulse to the light-projecting head 100 in order to drive the light-projecting part 102. A light-emitting element 104 of the light-projecting part 102 is driven by an oscillation pulse issued from a light-projection power controlling circuit 302 of the controller 300, and emits pulse light toward an object to be detected on the outside. Light received by the light-receiving part 202 is photoelectrically converted in a light-receiving element 204, and transmitted to a control part 308 through a light-receiving element amplifying circuit 206, an amplification circuit 304 and an A/D converter 306 of the controller 300. Detection in synchronization with the pulse light is thereby performed, and a detection signal is further converted to a direct current signal or the like, and then outputted as an ON/OFF signal representing a detection result from an I/O circuit 360.

### Light-Projecting Head 100:

The light-projecting head 100 includes a light-emitting element 104 for light-projection as the light-projecting part 102 and a light-projecting circuit 106 for driving this light-emitting element 104. A LED, a LD or the like is adoptable as the light-emitting element 104. The light-projecting circuit 106 is provided with a light-projecting APC circuit 108 and a light-receiving element 110 for monitoring such as a monitor PD. The light-projecting APC circuit 108 is controlled such that an output of the light-emitting element 104, namely a light-emitting amount, is a predetermined value.

The light-projecting head 100 includes an indicator light 112 for indicating a light-emitting amount or the like. The indicator light 112 and the light-projecting APC circuit 108 receive driving power respectively from the light-projection power controlling circuit 302 and a head indicator light power controlling circuit 310 of the controller 300 via a light-projecting power-supply line. A light-receiving element 110 for monitoring of the light-projecting head 100 is connected to a monitor signal amplifying circuit 114, and a light-receiving amount is transmitted to a LD light-receiving amount monitoring circuit 312 of the controller 300 via a monitor line included in the head cable 400. The LD light-receiving amount monitoring circuit 312 supplies a light-receiving amount signal, having been converted to a digital signal via an A/D converter 314, to the control part 308. The control part 308 performs feedback control in which the light-projection power controlling circuit 302 is controlled based on the light-emitting amount detected by the light-receiving 110 for monitoring such that the light-emitting amount is a predetermined value, and a current amount of a light-projecting APC circuit 108 of the light-projecting head 100 is adjusted, to drive the light-emitting element 104.

### Light-Receiving Head 200:

A light-receiving circuit 208 for driving the light-receiving element 204 is provided. The light-receiving circuit 208 is provided with the light-receiving element amplifying circuit 206, a light-receiving part power circuit 210, and the like. The light-receiving element 204 is connected to the light-receiving element amplifying circuit 206, and an amount of light received in the light-receiving element 204 is amplified in the light-receiving element amplifying circuit 206, and transmitted to the amplification circuit 304 of the controller 300 via a signal line included in the head cable 400. An analog signal amplified in the controller amplifying circuit 304 is converted to a digital signal via the A/D converter 306, and inputted into the control part 308. Thereby, the light-receiving amount of the light-receiving element 204 is detected by the controller 300 to make a determination on the detection, and a determination result is finally outputted from the I/O circuit 360.

A light-receiving part power circuit 210 is a circuit for supplying driving power for the light-receiving head 200, and is connected to a head power circuit 316 of the controller 300 via a power-supply line of the head cable 400. A head power circuit 316 is controlled by the control part 308 of the controller 300.

### Controller 300:

The controller 300 can be connected with a plurality of kinds of sensor heads, irrespective of a transmissive sensor head and a reflective sensor head, and is provided with an identification function to identify each sensor head. Specifically, the controller 300 includes a light-projecting head identifying circuit 318 for identifying the light-projecting head 100, and a light-receiving head identifying circuit 320 for identifying the light-receiving head 200. These head identifying circuits 318, 320 respectively detect identification signals of the light-projecting head 100 and the light-receiving head 200, and transmit the signals to the control part 308 via A/D converters 322, 324, and hence each of the sensor heads is identified by the control part 308.

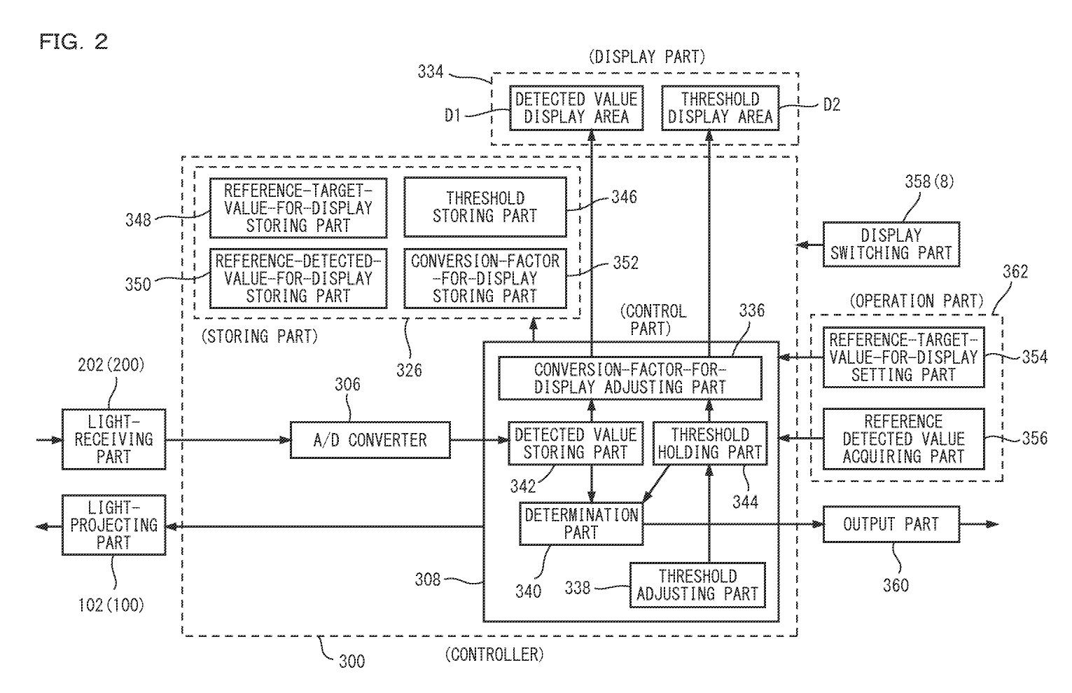

The control part 308 is connected with the light-projection power controlling circuit 302, the head indicator light power controlling circuit 310, the LD light-receiving amount monitoring circuit 312, the controller amplifying circuit 304, the head identifying circuit 320, the head power circuit 316, and the like. Further, the control part 308 is connected with a storing part 326 for storing a variety of set values and the like, a display circuit 328 for displaying information on the controller 300 side, a switch input circuit 330 that is connected with an operation part 362 (FIG. 2) as a user interface for accepting adjustment of a set value, an I/O circuit 360 for performing an input into and an output from the outside, and the like, and these circuits are driven by a controller power circuit 332.

Next, a configuration to realize an adjustment function of the photoelectric switch 1 will be described based on the block diagram shown in FIG. 2. The controller 300 is provided with the control part 308 for performing a variety of controls, the storing part 326 for storing a set value and the like, a display part 334 for displaying a threshold, a detected value, a target value and the like, the operation part 362 for performing a variety of operations and setting, a display switching part 358 for switching a display mode in the display part 334, an output part 360 for outputting a detection result, and the A/D converter 306 for converting an analog signal of an amount of light received in the light-receiving part 202 to a digital signal. Further, the control part 308 includes a conversion-factor-for-display adjusting part 336, a threshold adjusting part 338, a determination part 340, a detected value storing part 342 that stores a detected value, and a threshold holding part 344 for holding a threshold. Further, the control part 308 is connected with the storing part 326, and the storing part 326 includes a threshold storing part 346, a reference-target-value-for-display storing part 348, a reference-detected-value-for-display storing part 350, and a conversion-factor-for-display storing part 352. The control part 308 is configured by a microprocessor, such as a CPU. The operation part 362 of the controller 300 includes a reference-target-value-for-display setting part 354, and a reference detected value acquiring part 356.

In the photoelectric switch 1, the light-receiving part 202 receives light, emitted from the light-projecting part 102 toward the object to be detected, the determination part 340 compares an amount of the received light as a detected value with a threshold, and the output part 360 outputs a result of the determination. Specifically, the determination part 340 compares a digital value as the inputted detected value with the threshold, and the output part 360 outputs to an external apparatus the result as a binary signal showing the presence or absence of the object to be detected.

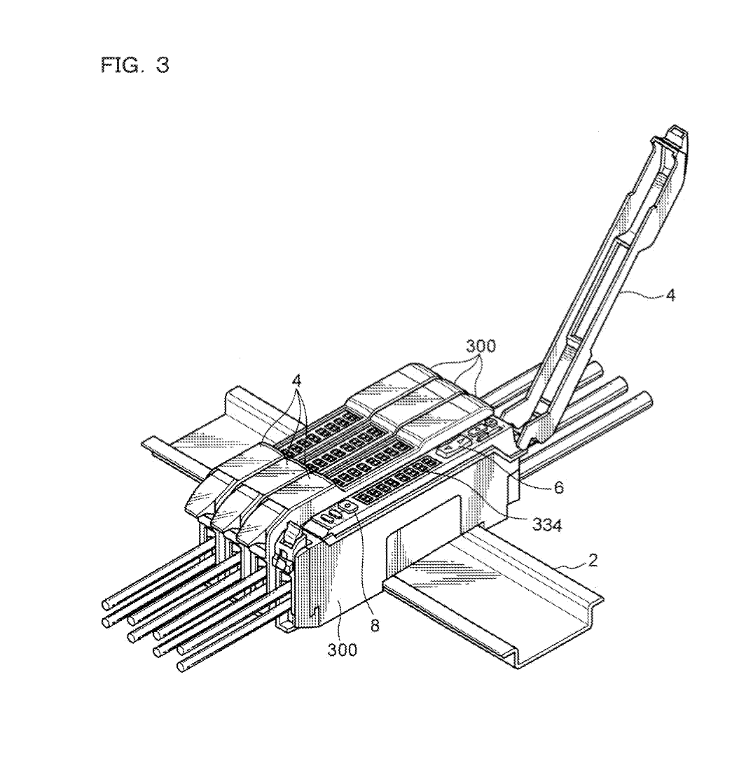

FIG. 3 is a perspective view of the controller 300 seen from obliquely above, where an example of four controllers 300 being mutually adjacently arranged on a DIN rail 2 is illustrated, and one controller 300 among them with its upper cover 4 in an open state is illustrated.

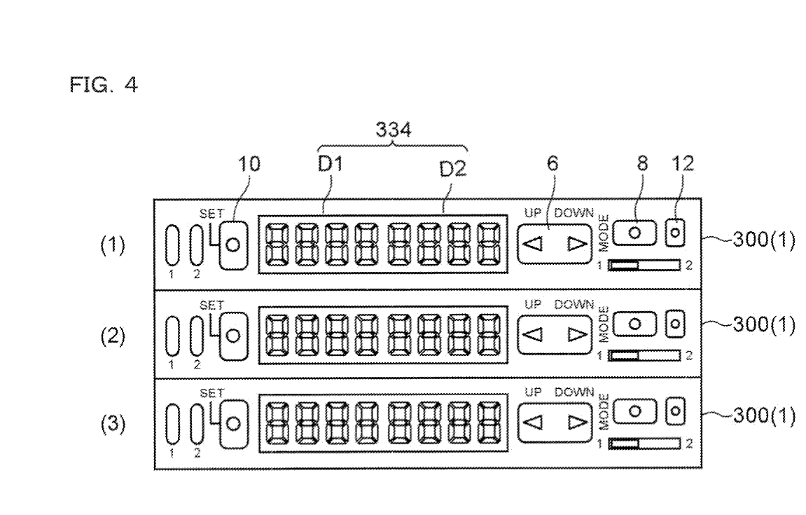

FIG. 4 is a plan view of the photoelectric switch 1. With reference to FIGS. 3 and 4, the display part 334 is made up of two horizontally arranged 4-digit 7-segment displays D1, D2, and a detected value (light-receiving amount), a threshold, and the like are displayed using these two 4-digit 7-segment displays D1, D2. The display part 334 may be configured by a liquid crystal display.

Adjacently to the displays D1, D2, a swing type up-down button 6, a mode button 8, a set button 10, a preset button 12, and the like are arranged.

Returning to FIG. 2, the controller 300 has the display switching part 358, and this display switching part 358 is configured by the above mode button (M button) 8 and the preset button 12. By operation of the mode button 8 and the preset button 12, it is possible to switch between a non-conversion display mode, on which a detected value (light-receiving amount) and a threshold are displayed as they are, and a conversion display mode, on which a detected value for display (light-receiving amount for display) and a threshold for display, having been converted using a conversion factor for display or a conversion formula for display, are displayed.

Operating the set button 10 and the up-down button 6 can adjust the threshold. The up-down button 6 is used for changing a threshold and other numeric values, determining an option, and the like. Since an object to be displayed, a display aspect, a display switching operation and display mode switching of the controller 300 are described in detail in Unexamined Japanese Patent Publication No. 2006-351380, descriptions of those will be omitted by reference to Unexamined Japanese Patent Publication No. 2006-351380. The preset button 12 is not described in Unexamined Japanese Patent Publication No. 2006-351380. A function allocated to the preset button 12 will be described later.

Although the transmissive photoelectric switch 1 has been described above, a reflective photoelectric switch has substantially the same structure, and the present invention is applicable to the transmissive photoelectric switch and the reflective photoelectric switch. Further, the present invention is also applicable to a fiber-type photoelectric switch in which the light-emitting element 104 for light projection, the light-projecting circuit 106 for driving this light-emitting element 104, and the like, as well as the light-receiving circuit 208 for driving the light-receiving element 204, and the like, are built in the controller 300, and the light-projecting head 100, the light-receiving head 200 and the controller 300 are connected by an optical fiber.

### Scaling Function:

In the case of using the plurality of controllers 300 in a horizontally arranged manner, a display of the display part 334 of each of the photoelectric switches 1 (controllers 300) is desirably matched. It is the scaling function that meets this desire. Specifically describing, it is assumed that two photoelectric switches A and B are set on the same conditions. It is assumed that a detected value (light-receiving amount) of the photoelectric switch A is “4850” and that of the other photoelectric switch B is “5150” in the state of 100%-light entrance, due to the difference in optical characteristics between the photoelectric switches A, B. It is to be noted that “4850” and “5150” above are values after zero-adjustment. As thresholds, generally, half values thereof, namely “2425” is automatically set in the one sensor A and “2575” is automatically set in the other sensor B.

The scaling function is to artificially change a detected value (light-receiving amount) to be displayed in the display part 334 of the controller 300, to match display values in the photoelectric switches A and B with respect to the detected values (light-receiving amount) and the thresholds. That is, when the user selects the scaling function, the mode is switched to a “scaling display mode” with respect to the displays of the display parts 334 of the photoelectric switches A, B.

On the scaling display mode, a display value (target value, namely initial value) of a detected value in the state of 100%-light entrance is adjusted so as to be “5000” in each of the photoelectric switches A and B. Further, when a threshold is automatically set to be a half value of the detected value, “2500” is set as a scaling display value of the threshold in each of the photoelectric switches A, B.

Specifically, when the scaling function (scaling display mode) is selected by the user, a value obtained by multiplying the detected value (light-receiving amount) by the scaling display conversion factor (scaling display value of the light-receiving amount) is displayed in the display part 334. When described using the above example, a scaling display conversion factor of the light-receiving amount of the one photoelectric switch A is “5000/4850”, and a scaling display conversion factor of the light-receiving amount of the other photoelectric switch B is “5000/5150”. In the photoelectric switch A, the scaling display value of the light-receiving amount is computed based on a formula: light-receiving amount×(5000/4850), and a target value thereof becomes “5000”. On the other hand, in the photoelectric switch B, the value is computed based on a scaling display conversion formula: light-receiving amount×(5000/5150), and a target value thereof becomes “5000”. The value of the scaling display conversion factor of the light-receiving amount is held until the user performs an operation to reset the scaling function.

Similarly, a value obtained by multiplying the threshold by the scaling display conversion factor (scaling display value of the threshold) is displayed in the display part 334. When described using the above example, a scaling display conversion factor of the threshold of the one photoelectric switch A is “5000/4850”, and a scaling display conversion factor of the threshold of the other photoelectric switch B is “5000/5120”. Therefore, in the photoelectric switch A, the scaling display value of the threshold is computed based on a formula: 2425×(5000/4850), and the value becomes “2500”. Further, in the photoelectric switch B, the value is computed based on a formula: 2575×(5000/5150), and the value becomes “2500”. This scaling value of the threshold is held until the user performs a resetting operation.

Using the scaling display mode, the user can match display values of light-receiving amounts and thresholds of the plurality of photoelectric switches.

### Preset Function:

As a form developed from the above scaling function to convert a light-receiving amount to an artificially defined display value and make a display using this converted value, a display range is also artificially defined, for example independently of the number of gradations (number of bits) of the A/D converter 306, to provide simpler operability, while providing a display aspect made to be sensuously and intuitively recognized. For example, just by clicking a set button once in the transmissive type in a state without a object, a scaling function, namely a preset function, is set such that a display value of a light-receiving amount in the state without the object is “100”, and a light-receiving amount for display in accordance with this scaling function is displayed in one of the 4-digit 7-segment displays D1, D2. At this time, the light-receiving amount is displayed within a range defined by “0 (zero)” and “100”, and it is configured such that, when the light-receiving amount for display exceeds “100”, 100 is displayed in one of the 4-digit 7-segment displays D1, D2.

In the operation of a preset display mode for executing this preset function, the light-receiving amount of the photoelectric switch 1 is displayed in the range of “0 to 100”, as described above. Further, the threshold is also preferably converted to an artificially defined display value, and displayed using this converted display value. At this time, the threshold for display in accordance with the preset function is displayed in the other of the 4-digit 7-segment displays D1, D2. According to this, the threshold can also be collectively managed by the administrator.

The preset display function is applicable to the reflective photoelectric switch as well as the transmissive switch. Therefore, in the following description, when the transmissive type and the reflective type are collectively called, the term “photoelectric switch” is used.

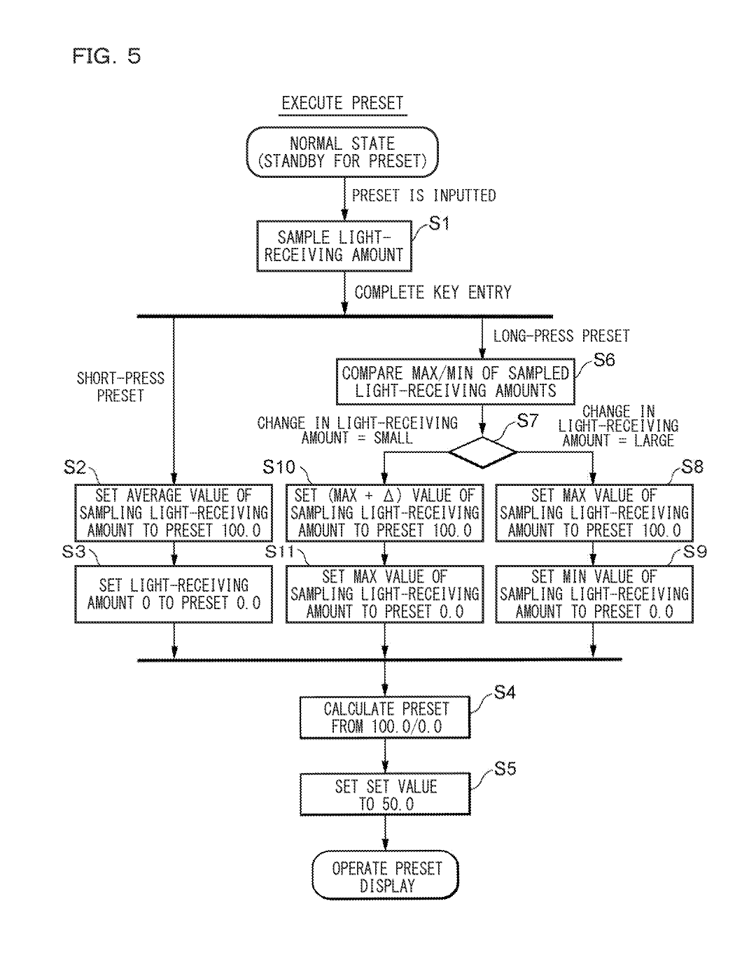

### First Operation Mode (S2, S3 of FIG. 5):

On a first operation mode, a light-receiving amount is sampled and the preset display value “100” is set to this actual light-receiving amount. Since a half value of a light-receiving amount is generally automatically set as a threshold, a preset display value “50” is allocated to this threshold (set value). Further, a preset display value “0 (zero)” is allocated to a light-receiving amount “0 (zero)”. Then, preset display conversion factor and conversion formula are created based on these values, to operate a preset display mode based on these scaling conversion formula and conversion factor. The preset display conversion factor and conversion formula are created in this case in accordance with the same concept as the case of the foregoing scaling function. As a modified example, the preset display value “0 (zero)” may be set to the light-receiving amount, to allocate the preset display value “100” to the light-receiving amount “0 (zero)”. Setting processing on this first operation mode is executed by “short-pressing” the preset button 12, the short-pressing being to press down the button for a relatively short period of time.

FIGS. 5 to 10 are views for explaining internal processing of the preset function. FIG. 5 is setting processing that is performed by the user in a first stage. With reference to FIG. 5, the photoelectric switch 1 performs processing for sampling a light-receiving amount while the preset button 12 is kept pressed down (S1). Once the preset button 12 is released, it is determined that the preset button 12 has been “short-pressed” when a period over which the preset button 12 is kept pressed down is within predetermined time, and the process goes to Step S2, where an average value of the sampled light-receiving amounts is obtained and “100” is set to this average value (Ave) as the preset display value.

In addition, although the value that is set with “100” is exemplified by the average value of the sampled light-receiving amounts, it may for example be a value representing the sampled light-receiving amounts, such as a value obtained by subtracting a predetermined value from the average value or dividing the average value by a predetermined value, or a minimal value.

In Step S3, the photoelectric switch 1 allocates the preset display value “0 (zero)” to the light-receiving amount “0 (zero)” which is previously stored in the photoelectric switch 1, and creates a preset display conversion formula for the light-receiving amount based on the preset display values “100” and “0” (S4). This preset display conversion formula for the light-receiving amount (preset display conversion factor) is created based on substantially the same concept as the foregoing scaling computation. In next Step S5, the photoelectric switch 1 allocates the preset display value “50” to the set value (threshold). As thus described, the setting processing with respect to the preset display value is completed by pressing down the preset button 12 for relatively a short period of time (short-pressing).

When a description is given using the transmissive photoelectric switch 1, the state “with the object” (“present object”) is that light is totally blocked and the light-receiving amount is “0 (zero)”. Therefore, in the state “with the object”, the preset display value “0” is displayed in the display part 334 (FIG. 4). On the contrary, in the state “without the object” (“absent object”), the preset display value of the light-receiving amount is displayed, and a target value of this preset display value is “100”.

Accordingly, in the operation of the photoelectric switch on the preset display mode, a numeric value is displayed in the range from “0” to “100” with respect to the light-receiving amount, while a numeric value below “0” or over “100” is not displayed, and in such cases, “0” and “100” are respectively displayed. As a modified example, the foregoing set values of the preset display values may be reversed such that the preset display value “100” is displayed in the display part 334 in the state “with the object”, and the preset display value “0” is displayed in the state “without the object”.

In initial preset setting, numeric values of the horizontally arranged controllers 300 (FIG. 4) are uniformed by “0” and “100”, and hence the same merit as that of the foregoing scaling display can be provided to the user. Upon occurrence of deterioration in capacity (e.g., light amount decrease, contamination) or the like of the photoelectric switch over time, the preset display is stopped at a value lower than “100” (e.g., a maximal value of the preset display is “95”), and hence, looking at this numeric value of “95” allows intuitive grasping of an operating state and a state change of the photoelectric switch.

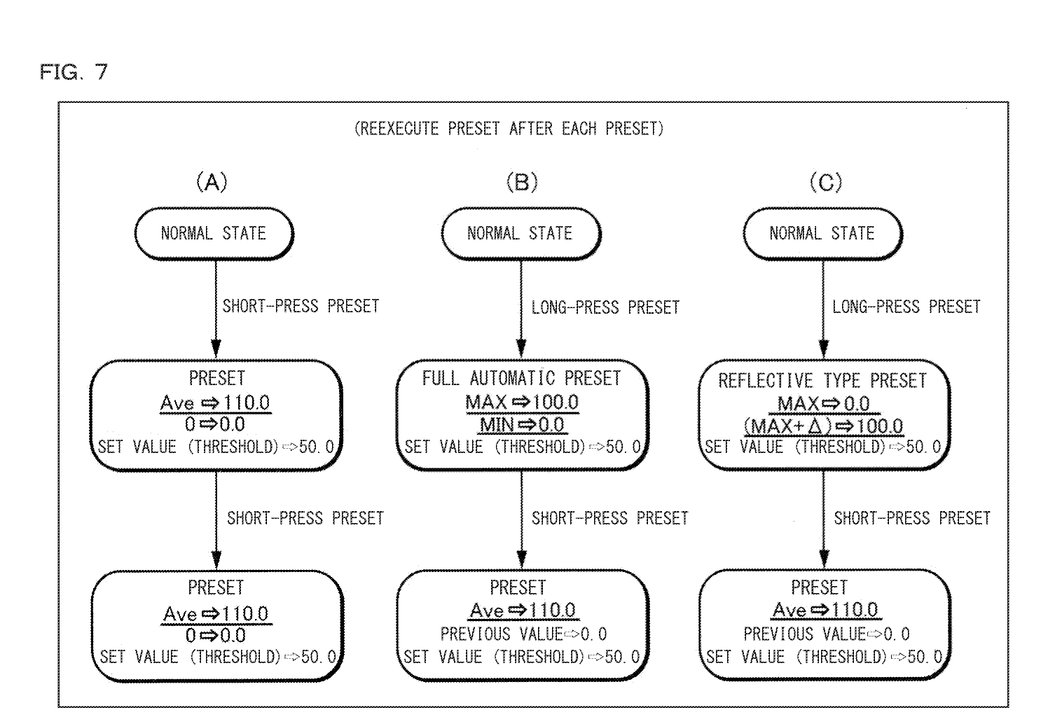

Each of FIGS. 7A to 10A is a diagram for explaining that the preset display value and the preset display conversion factor, having been typically set in the processing of Steps S1 to S5 (FIG. 5) can be reset by simple operations.

With reference to FIG. 7A, when the preset button 12 is “short-pressed” after parameter setting in Steps S1 to S5 of FIG. 5 or during operation of the preset display mode, it is possible to change the setting of an internally processed value of the preset display value, which is the target value “100”. Parameters other than this internally processed value are held. This change in internally processed value can be made, for example, by operating the up-down button 6. In the middle step of FIG. 7A, a state is shown where the average current value (Ave) of the current light-receiving amounts has been set so as to be “110” by the internal processing. Setting a value over “100” as the internally processed value as thus described can prevent the preset display value from changing in response to variations in light-receiving amounts during the operation. In other words, when the internally processed value exceeds 100, “100” is displayed in the display part 334 since the display in the display part 334 becomes saturated at the preset display value “100”.

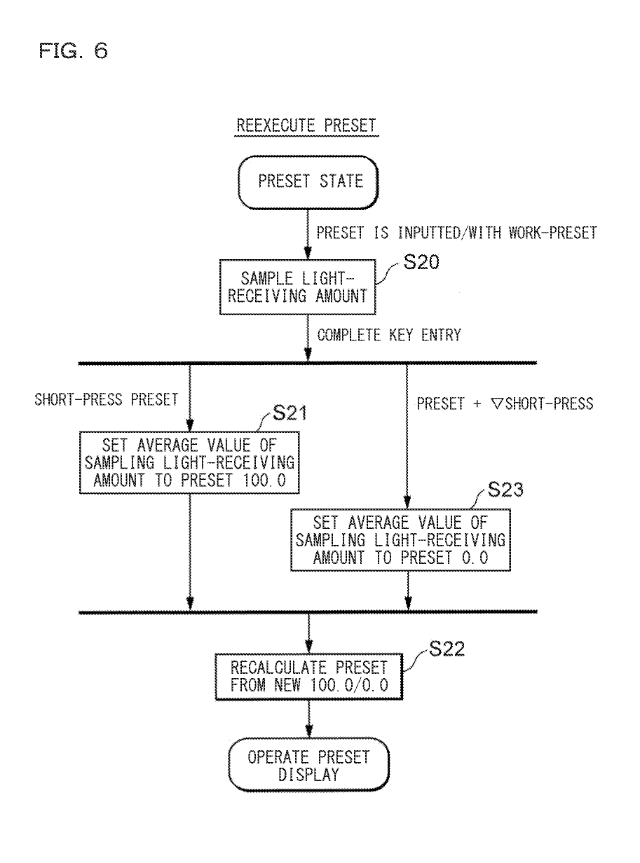

During the operation of the preset display mode, simply operating the preset button 12 makes it possible, as many times as required, to change the setting of the internally processed value with respect to the preset display value “100”, or to substitute the light-receiving amount to be used for the preset display conversion formula so as to update the conversion factor (lower step of FIG. 7A). Specifically, with reference to a flowchart of FIG. 6, the photoelectric switch 1 performs sampling of the current light-receiving amount by pressing down the preset button 12 (S20), and executes an update to set an average value of the sampled light-receiving amounts (light-receiving amounts corresponding to the preset display value “100”) to the preset display value “100” (S21). Then, the photoelectric switch 1 calculates a preset display conversion factor and the like in similar manners to Steps S4, S5 by use of the held value as it is in terms of the preset display value “0 (zero)”, and performs resetting to this newly created preset display conversion formula.

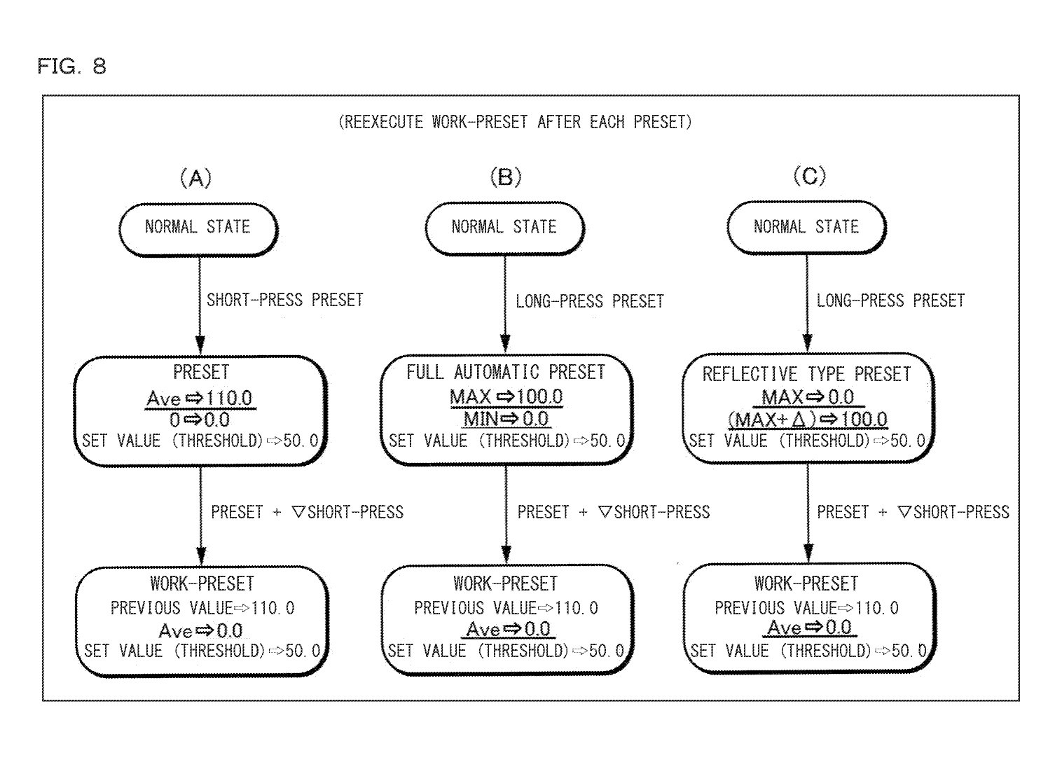

When an operation based on this newly created preset display conversion formula is disadvantageous, the process returns to the flowchart of FIG. 6, and the photoelectric switch 1 performs sampling of the current light-receiving amount by pressing down the preset button 12 (S20). When determining that the preset button 12 and another button have been short-pressed together, the photoelectric switch 1 executes setting of an average value of the sampled actual light-receiving amounts (light-receiving amounts corresponding to the preset display value “0”) to the preset display value “0” (S23), and creates a preset display conversion formula obtained by substituting the above actual light-receiving amount for the light-receiving amount with respect to the preset display value “0” in the already created preset display conversion formula in Step S22 (S22), to perform an operation of the preset display mode based on this newly set conversion formula (lower step of FIG. 8A). The preset display conversion formula in Step S22 is created as follows.

Herein, the average value (previous value) of the sampled actual light-receiving amounts having already been made to correspond to the preset display value “100” is Vpre (hereinafter referred to as “value corresponding to “100”), the average value of the sampled actual light-receiving amounts which is made to correspond to the preset display value “0” this time is Vcur (hereinafter referred to as “value corresponding to “0”), the actual light-receiving amount obtained during the operation of the preset display mode is X, and the preset display value that is displayed on one of the 4-digit 7-segment displays D1, D2 is P. The value Vpre corresponding to “100” and the value Vcur corresponding to “0” are compared with each other, and when Vpre>Vcur, a preset display conversion formula is selected, by which the preset display value increases with increase in actual light-receiving amount. On the other hand, when Vpre<Vcur, the preset display conversion formula is selected, by which the preset display conversion formula decreases with increase in actual light-receiving amount.

In the former case, the preset display conversion formula is as follows.

P=100×(X−Vcur)/(Vpre−Vcur):Vcur≦X≦Vpre,

P=0:X<Vcur, P=100:X>Vpre

In the latter case, the preset display conversion formula is as follows.

P=100×(Vcur−X)/(Vcur−Vpre):Vpre≦X≦Vcur,

P=0:X>Vcur, P=100:X<Vpre

It is to be noted that, when the value Vpre corresponding to “100” and the value Vcur corresponding to “0” are substantially identical, it becomes impossible to set a threshold for stably determining the presence or absence of the object, and hence in such a case, the update of the preset display conversion formula is not executed.

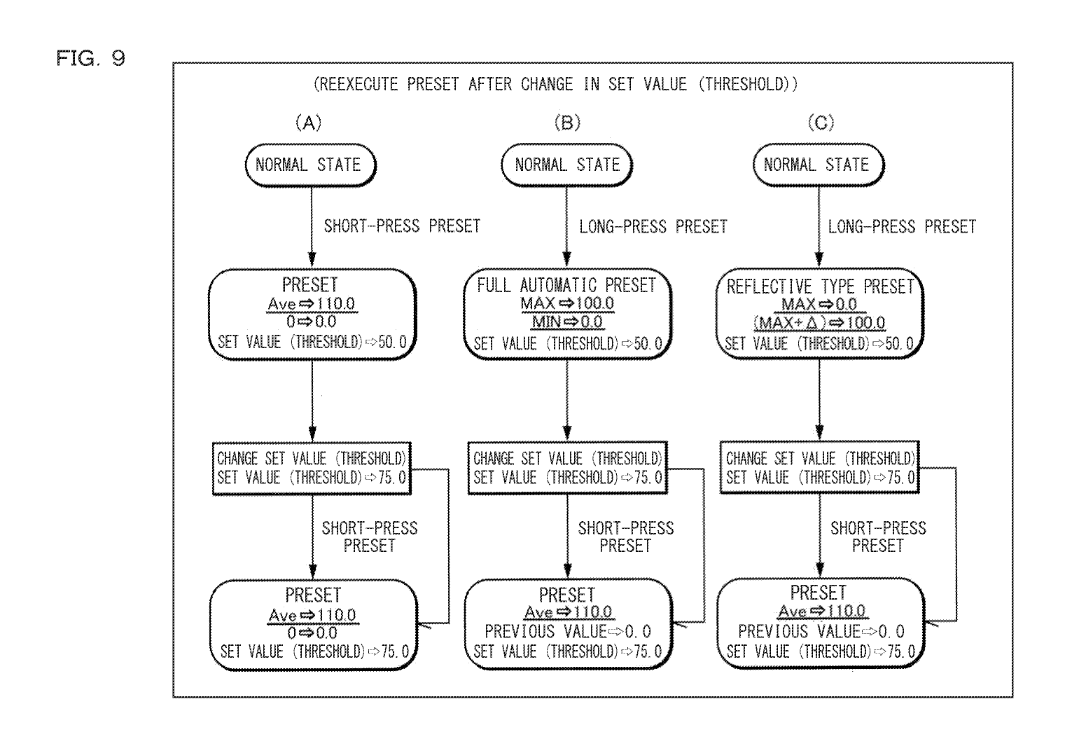

After setting of the parameters in Steps S1 to S5 of FIG. 5, other than the foregoing setting change in internally processed value of the preset display value of the light-receiving amount of the target value “100” with reference to FIG. 7A, the preset display value of the threshold can also be changed (FIG. 9A). With reference to FIG. 9A, a preset display conversion formula is newly set, and during the operation of the preset display mode based on the preset display conversion formula, the preset display value “50” can be changed, for example, by operating the up-down button 6. The change may be made to the preset display value “50” of the threshold, or may be made to the threshold itself. For example, when a change is made to the preset value “50” of the threshold, the setting of the threshold is also changed, in accordance with this change. At the time of this change in threshold, other parameters and preset display conversion formulas are held as in the previous states. The third step of FIG. 9A shows a state where the preset value of the threshold is changed to “75”.

As described above, the preset button 12 is once pressed down to perform sampling of the light-receiving amount and set a preset display conversion factor or a preset display conversion formula, and thereafter the preset button 12 is simply operated, whereby it is possible to reset the preset display conversion factor or the preset display conversion formula based on the latest light-receiving amount (Steps S2 to S5 of FIG. 5). It should be noted that, the preset display conversion factor or the preset display conversion formula has been reset based on the latest light-receiving amount by once pressing down the preset button 12 to perform sampling of the light-receiving amount and set a preset display conversion factor or a preset display conversion formula and then “short-press” the preset button 12, but when the preset button 12 is once pressed down to perform sampling of the light-receiving amount and set a preset display conversion factor or a preset display conversion formula and thereafter the preset button 12 is “long-pressed”, the mode is shifted to a non-conversion mode on which the detected value (light-receiving amount) and the threshold are displayed as they are.

Further, the lower step of FIG. 9A is a diagram for explaining a setting change at the time of short-pressing the preset button 12. When updating the preset display conversion formula in addition to the change in threshold (“50” to “75”) is requested, returning to the flowchart of FIG. 6, the preset button 12 is pressed down to perform sampling of the current light-receiving amount (S20), and upon short-pressing of the preset button 12, setting of an average value of the sampled actual light-receiving amounts (light-receiving amounts corresponding to the preset display value “100”) to the preset display value “100” is executed (S21), and a preset display conversion formula value is created in Step S22, thereby to set this newly set conversion formula (bottom step of FIG. 9A). In calculation of this new conversion formula, as for the parameters other than the threshold “75” and the sampled current light-receiving amount, conventional values having been held are adopted. In addition, although the example has been described where the threshold after changed is adopted for calculation of the new conversion formula, a predetermined value such as “50” may be adopted as the threshold regardless of the change in threshold.

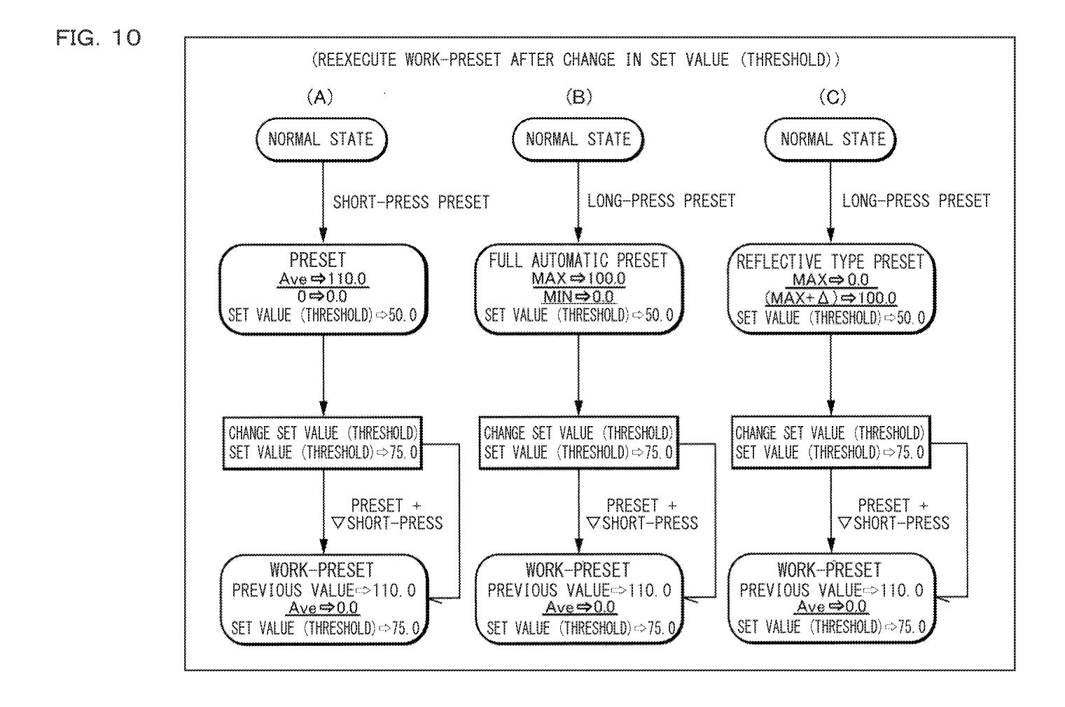

Moreover, the bottom step of FIG. 10A is a diagram for explaining a setting change at the time of short-pressing the preset button 12 and another button together. On top of the change in threshold (“50” to “75”), the preset display value “0 (zero)” is updated based on the latest information. That is, returning to the flowchart of FIG. 6, by short-pressing the preset button 12 and another button together, setting of an average value of the sampled actual light-receiving amounts (light-receiving amounts corresponding to the preset display value “0 (zero)”) to the preset display value “0 (zero)” is executed (S23), and the preset display conversion formula (threshold “75”) is then created in Step S22, thereby to set this newly set conversion formula (FIG. 9A). In calculation of this new conversion formula, as for the parameters other than the sampled current light-receiving amount (light-receiving amount corresponding to the preset display value “0 (zero)”), conventional values having been held are adopted.

When the foregoing preset display according to Steps S2, S3 of FIG. 5 is referred to the first operation mode, this first operation mode is on the basis of creating a preset conversion formula by setting, based on the sampled light-receiving amount, a preset display value of the target value “100” to the measured light-receiving amount, and using the other parameters based on the data already held by the photoelectric switch. Therefore, this first operation mode is advantageous in the case of performing sampling of the light-receiving amount, to be performed in Step S1, in the state “without the object”. The, it is also possible to update the preset conversion formula based on the newly sampled light-receiving amounts during the operation (S21, S22 of FIG. 6). Furthermore, as the need arises, the preset conversion formula can be updated after the light-receiving amount corresponding to the preset display value “0 (zero)” in the state “without the object” has been measured and the preset display value “0 (zero)” has been set to this measured light-receiving amount (S23, S22 of FIG. 6).

Second Operation Mode (S8, S9 of FIG. 5):

On a second operation mode, typically in the state of carrying the object, a light-receiving amount is sampled, and the preset display values “100” and “0” are set to a maximal value (MAX) and a minimal value (MIN) as measured values of the light-receiving amount. In the photoelectric switch, with a threshold being automatically set to a middle value between the maximal value and the minimal value, the preset display value “50” is allocated to this automatically set threshold. Then, preset display conversion factor and conversion formula are created based on these values, to operate a preset display mode based on these conversion formula and conversion factor. The creation of the preset display conversion factor and conversion formula in this case are performed in accordance with the same concept as the case of the foregoing scaling function. As a modified example, the preset display value “0 (zero)” may be set to the maximal value (MAX), and the preset display value “100” may be set to the minimal amount value (MIN). Setting processing on this second operation mode is executed, for example, by “long-pressing the preset button 12, which is to press down the button for a long period of time by the operation different from the setting processing on the first operation mode. That is, the photoelectric switch 1 is preferably configured so as to monitor the operation of the preset button 12 and select the operation mode in accordance with the difference in operation.

The second operation mode will be described specifically with reference to FIG. 5 (S23). This second operation mode is advantageous in the case of performing sampling of the light-receiving amount in a state where the object is moving. The photoelectric switch 1 performs processing for sampling a light-receiving amount while the preset button 12 is kept pressed down (S1). Once the preset button 12 is released, it is determined that the preset button 12 has been “long-pressed” when a period over which the preset button 12 is kept pressed down exceeds predetermined time, and the process then goes to Step S6, where the maximal value (MAX) and the minimal value (MIX) of the sampled light-receiving amounts are compared with each other. Then, the photoelectric switch 1 determines that the light-receiving amount has been sampled in the state of the object being moved when the difference between the maximal value and the minimal value is larger than a predetermined value, and the process then goes to Step S8.

It is to be noted that, although the example of comparing the maximal value (MAX) and the minimal value (MIX) of the sampled light-receiving amounts has been shown, the comparison is not necessarily performed. This comparison is implemented for the purpose of automatically distinguishing between the second operation mode and a later-mentioned third operation mode due to the second operation mode and the third operation mode being in common in that the preset button 12 is to be “long-pressed”. Therefore, when there is no need for distinguishing the operation modes for example by varying the operation procedures for the preset button 12 on the second operation mode and the third operation mode, the process may skip this comparison, and goes to Step S8.

In Step S8, the preset display value “100” is set to the maximal value (MAX). Then in the next Step S9, the preset display value “0 (zero)” is set to the minimal value (MIX). That is, the preset display values “100” and “0 (zero)” are set based on the measured values. Then, a preset conversion formula is created based on these two set parameters in the foregoing Step S4, and a middle value between the maximal value and the minimal value is set as a preset display value of the threshold (S5).

The preset conversion formula in above Step S5 is created as follows. Herein, a maximal value (MAX) of sampled actual light-receiving amounts having already been made to correspond to the preset display value “100” is Vmax (hereinafter referred to as “value corresponding to “100”), a minimal value (MIN) of the sampled actual light-receiving amounts which is made to correspond to the preset display value “0” is Vmin (hereinafter referred to as “value corresponding to “0”), an actual light-receiving amount obtained during the operation of the preset display mode is X, and a preset display value that is displayed on one of the 4-digit 7-segment displays D1, D2 is P.

The preset display conversion formula is as follows.

P=100×(X−Vmin)/(Vmax−Vmin):Vmin≦X≦Vmax,

P=0:X<Vmin, P=100:X>Vmax

That is, in this second operation mode, the preset display values “100”, “0 (zero)” are set to the maximal value and the minimal value of the light-receiving amount measured by sampling, and based thereon, preset conversion factor and conversion formula are set.

It is to be noted that, although the maximal value and the minimal value of the light-receiving amount have been set to the preset display value “100”, “0 (zero)”, this is an example where the maximal value and the minimal value are selected as representative values representing the states “with the object” and “without the object”. These representative values are not restrictive so long as being representative values obtained based on the light-receiving amount measured by sampling as well as representing the states “with the object” and “without the object”. Values offset by predetermined amounts from or values being predetermined rates of the maximal value and the minimal value may be regarded as representative values representing the states “with the object” and without the object.

With reference to FIG. 7B, when the preset button 12 is long-pressed, the preset conversion formula on the second mode is set as described above (middle step of FIG. 7B). By short-pressing the preset button 12 during the operation on this second operation mode, it is possible to change the setting of the internally processed value of the preset display value as the target value “100. This is similar to the one described with reference to FIG. 7A. That is, in a state where the parameters other than this internally processed value are held, only the setting of the internally processed value of the preset display value as the target value “100” can be changed. The state of the set value after the change to an internally processed value “110” is shown on the lower step of FIG. 7B.

Long pressing the preset button 12 can set a preset conversion formula based on the maximal value and the minimal value on the basis of the foregoing preset conversion formula on the second operation mode, namely the current measured values. Also in this case, the preset conversion formula is created in a state where the parameters other than the maximal value and the minimal value are held, and an operation of the preset display mode based on the preset conversion formula is executed (middle step of FIG. 8B).

After the preset conversion formula has once been created, the preset button 12 is further operated, thereby allowing resetting of the preset display value “100”, resetting of the preset display value “0 (zero)”, or shifting to a non-conversion display mode on which the detected value (light-receiving amount) and the threshold are displayed as they are.

After the preset conversion formula has once been created, when the photoelectric switch 1 determines that the preset button 12 and another button have been short-pressed together, the process goes to Step S23 of FIG. 6, where the average value of the light-receiving amounts corresponding to the preset display value “0 (zero)” is reset to the preset display value “0 (zero)”, and the preset conversion formula is updated based on this value. Also in this case, the preset conversion formula is created in a state where the parameters other than the updated minimal value are held (lower step of FIG. 8B).

Performing sampling of the light-receiving amount by long-pressing the preset button 12 as thus described can set the preset conversion formula based on the latest measured light-receiving amount by foregoing Steps S7 to S9 and Steps S4, S5 of FIG. 5 (second step of FIG. 9B). Further, at this time, the preset display value of the threshold can be changed by operating the up-down button 6 (figure of “75” in the third step of FIG. 9B). It is as described above that the threshold is changed with the change in this preset display value of the threshold.

Further, by short-pressing the preset button 12 and another button together, setting of an average value of the sampled actual light-receiving amounts (light-receiving amounts corresponding to the preset display value “0 (zero)”) to the preset display value “0 (zero)” is executed (S23 of FIG. 6), and the preset display conversion formula is then created in Step S22, thereby to set this newly set conversion formula (bottom step of FIG. 10B). In calculation of this new conversion formula, as for the threshold “75” and the other parameters, conventional values having been held are adopted.

It is to be noted that, similarly to the foregoing first operation mode, also on this second operation mode, after the preset button 12 has once been created, the preset display value “100” may be updated based on the latest light-receiving amount with respect to the light-receiving amount corresponding to the preset display value “100” by short-pressing the preset button 12 (S21 of FIG. 6), and the preset conversion formula may be made resettable based on this updated parameter (S22 of FIG. 6). Also in this case, the previous values are preferably used as for the other parameters.

The preset display conversion formula in Step S22 above is created as follows. Herein, an average value (previous value) of sampled actual light-receiving amounts having already been made to correspond to the preset display value “0” is Vpre (hereinafter referred to as “value corresponding to “0”), an average value of the sampled actual light-receiving amounts which is made to correspond to the preset display value “100” this time is Vcur (hereinafter referred to as “value corresponding to “100”), an actual light-receiving amount obtained during the operation of the preset display mode is X, and a preset display value that is displayed on one of the 4-digit 7-segment displays D1, D2 is P.

The value Vpre corresponding to “0” and the value Vcur corresponding to “100” are compared with each other, and when Vpre<Vcur, a preset display conversion formula is selected, by which the preset display value increases with increase in amount of actual light-receiving amount, while when Vpre>Vcur, a preset display conversion formula is selected, by which the preset display value decreases with increase in amount of actual light-receiving amount. In the former case, the preset display conversion formula is as follows.

P=100×(X−Vpre)/(Vcur−Vpre):Vpre≦X≦Vcur,

P=0:X<Vpre, P=100:X>Vcur

In the latter case, the preset display conversion formula is as follows.

P=100×(Vpre−X)/(Vpre−Vcur):Vcur≦X≦Vpre,

P=0:X>Vpre, P=100:X<Vcur

It is to be noted that, when the value Vpre corresponding to “0” and the value Vcur corresponding to “100” are substantially identical, it is impossible to set a threshold for stably determining the presence or absence of the object, and hence in such a case, the update of the preset display conversion formula is not executed.

Third Operation Mode (S10, S11 of FIG. 5):

A third operation mode is typically applied to the reflective photoelectric switch, but is also applicable to the transmissive photoelectric switch. A preset display value is set in consideration of variations in light-receiving amount on a background “without the object”. When a light-receiving amount deviating from the variations in light-receiving amount on the background is detected, the state “with the object” is determined and the preset display value “100” is also displayed. Naturally, the preset display value “100” or “0 (zero)” can be set to the state “without the object”, and the preset display value “0 (zero)” or “100” opposed to the above can be set to the state “with the object”. Setting processing on this third operation mode is executed when the preset button 12 is “long-pressed”, and also when the difference between the maximal value and the minimal value of the sampled light-receiving amounts is small. Naturally, setting processing on this third operation mode may be executed immediately upon operation of a button different from those on the first and second modes.

As a preferred aspect, a sensitivity setting device for setting a value which is extremely close to a detected value (light-receiving amount) and represents the background, although not detecting the background, as the threshold of the photoelectric switch when the operation of the preset display value is executed on this third operation mode or when the setting for this third operation mode is performed. It is thereby possible to provide the user with convenience due to the preset display while improving the detection accuracy of the photoelectric switch.

As described above, the third operation mode is effective especially when, for example, the difference in light-receiving amount between the background and the object to be detected is relatively small in detection by the reflective photoelectric switch. That is, according to the third operation mode, when the light-receiving amount makes even a slight change with the state “without the object”, namely the background, taken as a reference”, it is possible to operate the photoelectric switch and also display the preset display value “100” (or “0 (zero)”).

Specifically, Steps S1, S6, S7, S10, S11, S4, S5 of FIG. 5 show setting processing on the third operation mode. First, in Step S1, the light-receiving amount is sampled in the state “without the object”. Next, the maximal value (MAX) and the minimal amount value (MIN) of the sampled light-receiving amounts are compared with each other (S6), to see an amount of change in light-receiving amount, namely an amount of variations in light-receiving amount on the background, and in Step S10, the preset display value “100” is set to a value obtained by adding a predetermined value (Δ) to the maximal value (MAX) of the sampled light-receiving amounts. Herein, as the predetermined value (Δ), a value may be set which is extremely close to a detected value (light-receiving amount) representing the background, although not detecting the background.

In next Step S11, the preset display value “0 (zero)” is set to the maximal value (MAX) of the measured current light-receiving amounts, and the preset conversion formula is created and set based on the preset display values “100”, “0 (zero)” (S4). Then, in next Step S5, a threshold is allocated to a value obtained by adding half the predetermined value (Δ), and the preset display value “50” is set to this threshold.

The preset conversion formula in above Step S5 here is created as follows. Herein, the preset conversion formula can be represented by the following formula where a value obtained by adding the predetermined value (Δ) to a maximal value (MAX) of sampled actual light-receiving amounts having already been made to correspond to the preset display value “100” is Vmax+Δ (hereinafter referred to as “value corresponding to “100”), a maximal value (MAX) of sampled actual light-receiving amounts having already been made to correspond to the preset display value “0” is Vmax (hereinafter referred to as “value corresponding to “0”), an actual light-receiving amount obtained during the operation of the preset display mode is X, and a preset display value that is displayed on one of the 4-digit 7-segment displays D1, D2 is P.

P=100×(X−Vmax)/Δ:Vmax≦X≦Vmax+Δ,

P=0:X<Vmax, P=100:X>Vmax+Δ

It is to be noted that, although the above preset conversion formula is typically applied to the reflective photoelectric switch, for example, a preset conversion formula applied to the transmissive photoelectric switch is prepared, so that the reflective photoelectric switch and the transmissive photoelectric switch may be automatically distinguished using the operation of the preset button 12, the state of the object at the time of sampling, an identification signal of a sensor head, or the like. In the case of application to the transmissive photoelectric switch, the preset conversion formula in Step S5 is created as follows. Herein, the preset conversion formula can be represented by the following formula where a value obtained by subtracting the predetermined value (Δ) from a minimal value (MIN) of sampled actual light-receiving amounts having already been made to correspond to the preset display value “100” is Vmin−Δ (hereinafter referred to as “value corresponding to “100”), a minimal value (MIN) of sampled actual light-receiving amounts having already been made to correspond to the preset display value “0” is Vmin (hereinafter referred to as “value corresponding to “0”), an actual light-receiving amount obtained during the operation of the preset display mode is X, and a preset display value that is displayed on one of the 4-digit 7-segment displays D1, D2 is P.

P=100×(Vmin−X)/Δ:Vmin−Δ≦X≦Vmin,

P=0:X>Vmin, P=100:X<Vmin−Δ

According to this third operation mode, the photoelectric switch is operated even when some matter passes and the light-receiving amount slightly changes. As described above, a value which is extremely close to a detected value (light-receiving amount) and represents the background, although not detecting the background, is preferably set as the threshold. Accordingly, the above predetermined value (Δ) and the half value of the predetermined value (Δ) may be decided after an appropriate threshold has been obtained.

With reference to FIG. 7C, when the preset button 12 is long-pressed, a preset conversion formula on the third operation mode is set as described above (middle step of FIG. 7C). By short-pressing the preset button 12 during the operation on this third operation mode, it is possible to change the setting of an internally processed value of the preset display value, which is the target value “100. This is similar to the ones described with reference to FIGS. 7A, 7B. That is, in a state where the parameters other than this internally processed value are held, only the setting of the internally processed value of the preset display value as the target value “100” can be changed. The state of the set value after the change to an internally processed value “110” is shown on the lower step of FIG. 7C.

The light-receiving amount on the background is sampled by long-pressing the preset button 12 (S20 of FIG. 6), and the preset conversion formula is set based on the foregoing preset conversion formula on the third operation mode, namely the preset conversion formula based on the maximal value (MAX) and the predetermined value (Δ) on the basis of the measured values, thereby to execute the operation of the preset display mode based on the preset conversion formula. (middle step of FIG. 8C).

After the preset conversion formula has once been created, the preset button 12 is further operated, thereby allowing resetting of the preset display value “100”, resetting of the preset display value “0 (zero)”, or shifting to a non-conversion display mode on which the detected value (light-receiving amount) and the threshold are displayed as they are. In the photoelectric switch 1, when the preset conversion formula has once been created and thereafter the preset button 12 and another button are short-pressed together, the process goes to Step S23 of FIG. 6, where the light-receiving amount (MAX) corresponding to the preset display value “0 (zero)” is reset to the preset display value “0 (zero)”, and the preset conversion formula is updated based on this value. Also in this case, the preset conversion formula is created in a state where the parameters other than the maximal value (MAX) are held (lower step of FIG. 8B).

Performing sampling of the light-receiving amount on the background by long-pressing the preset button 12 as thus described can set the preset conversion formula based on the latest maximal value (MAX) and predetermined value (Δ) by foregoing Steps S10, S11 and Steps S4, S5 of FIG. 5, so as to execute the operation of the preset display mode based on the preset conversion formula (second step of FIG. 9C). Further, at this time, operating the up-down button 6 can change the preset display value of the threshold (figure of “75” in the third step of FIG. 9C). It is as described above that the threshold is changed with the change in this preset display value of the threshold.

Moreover, by short-pressing the preset button 12 and another button together after the preset conversion formula has once been created, setting of the maximal value of the sampled amounts (light-receiving amounts corresponding to the preset display value “0 (zero)”) to the preset display value “0 (zero)” is executed (S23 of FIG. 6, third step of FIG. 10C), and the preset display conversion formula is then created in Step S22, thereby to set this newly set conversion formula (bottom step of FIG. 10C). In calculation of this new conversion formula, as for the threshold “75” and the other parameters, conventional values having been held are adopted.

As described above, on the preset display mode, an arbitrary mode can be selected from the first to third modes to perform the preset display, whereby the photoelectric switch of either the transmissive type or the reflective type can provide the user with convenience in terms of display by the preset display with respect to a wide application range, including a mirror-surfaced object.

Further, even in the midst of the operation on the preset display mode, part of set values having already been set can be updated based on the latest light-receiving amount or a threshold can be changed by a simple operation, so as to optimize the preset display. Moreover, even in the midst of the operation on the preset display mode, an internally processed value can be reset by a simple operation. Hence it is possible not only to set and reset the preset display by simple operations, but also to expand the application range of the preset display.

Although the preferable examples of the present invention have been described based on the preset display mode, since the preset display and scaling display are common in that an artificially defined value is displayed with respect to a light-receiving amount, the skilled person in the art can read the foregoing examples in terms of the scaling display. Accordingly, the skilled person in the art would readily understand that the present invention is applicable to the preset display and scaling. For this reason, when the present invention is to be defined, the scaling display and the preset display are collectively called “artificial numeric display” and the terms “preset display” and “scaling display” are used when those are particularly specified. Moreover, although the example has been shown where the preset display conversion factor and the preset display conversion formula are obtained at the time of converting the light-receiving amount of the photoelectric switch to the preset display value, the present invention is not restricted to the forms of the conversion factor and the conversion formula, but such a form as a conversion table can also be adopted so long as showing a light receiving amount display conversion relation.

The present invention is applicable to a photoelectric switch in an arbitrary form of either a transmissive type or a reflective type. Further, the present invention is applicable to a technique of displaying a light-receiving amount by use of an artificial numeric value in a given range, represented by a scaling display and a preset display.

What is claimed is:

1. A photoelectric switch, which comprises a display part, and converts each of a light-receiving amount in a state “present object” and a light-receiving amount in a state “absent object” to an artificial numeric display value defined by a range of an upper limit and a lower limit, to display the display value of the light-receiving amount in the display part,
a light-receiving amount setting device setting a light-receiving amount measured by the photoelectric switch as a light-receiving amount corresponding to one value of the upper limit or the lower limit among parameters required for creating a light-receiving amount display conversion relation for converting a light-receiving amount of the photoelectric switch to the display value;
a light-receiving amount allocating device allocating a light-receiving amount that is held by the photoelectric switch prior to setting the light-receiving amount measured by the photoelectric switch as a light-receiving amount corresponding to the other value of the upper limit and the lower limit;
a light-receiving amount display conversion factor setting device creating the light-receiving amount display conversion relation based on the light-receiving amount measured by the photoelectric switch and the allocated light-receiving amount, to set this created light-receiving amount display conversion relation; and
a first conversion relation updating device substituting the allocated light-receiving amount for the light-receiving amount measured by the photoelectric switch as the light-receiving amount corresponding to the other value of the upper limit and the lower limit, to update the light-receiving amount display conversion relation.

2. The photoelectric switch according to claim 1, wherein
the display part is configured by a first display and a second display adjacent thereto,
the switch further has a threshold converting device for converting a threshold of the photoelectric switch to the display value in a range between an upper limit and a lower limit, and
during an operation mode on which the presence or absence of an object to be detected is detected while the display value of the light-receiving amount is displayed in the display part, the display value of the threshold is displayed on the first display and the display value of the light-receiving amount of the photoelectric switch is displayed on the second display.

3. The photoelectric switch according to claim 2, wherein, when the light-receiving amount display conversion relation is updated, the threshold is set based on a light-receiving amount measured by the photoelectric switch and set as a light-receiving amount corresponding to one value of the upper limit and the lower limit, and a light-receiving amount measured by the photoelectric switch and set as a light-receiving amount corresponding to the other value of the upper limit and the lower limit.

4. The photoelectric switch according to claim 1, wherein the switch further has a second conversion relation updating device that substitutes a measured current light-receiving amount for a light-receiving amount measured by the photoelectric switch and set as a light-receiving amount corresponding to one value of the upper limit and the lower limit, to update the light-receiving amount display conversion relation.

5. The photoelectric switch according to claim 1, wherein the upper limit is “100” and the lower limit is “0”.

6. The photoelectric switch according to claim 1, wherein the photoelectric switch is a separate photoelectric switch.
